(19) United States
(12) Patent Application Publication
(10) Pub. No.: US 2008/0046948 A1
(43) Pub. Date: Feb. 21, 2008

(54) CREATION, MANAGEMENT AND DELIVERY OF PERSONALIZED MEDIA ITEMS

(75) Inventor: Ellis M. Verosub, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(73) Assignee: Apple Computer, Inc.

(21) Appl. No.: 11/621,541

(22) Filed: Jan. 9, 2007

Related U.S. Application Data
(60) Provisional application No. 60/836,285, filed on Aug. 7, 2006.

(51) Int. Cl. H04N 7/173; G06F 3/00; G06F 13/00; H04N 5/445

(52) U.S. Cl. 725/117; 725/54; 725/116

(57) ABSTRACT

Improved techniques to facilitate generation, management and delivery of personalized media items for users are disclosed. Users are able to influence or control content within a media item being personalized. In one embodiment, personalized media items are podcasts. Users are able to influence or control the content in or with a podcast. In other words, a podcast can be created in accordance with a user's needs or specifications so that the content within a podcast is customized or personalized for the user.

### CROSS-REFERENCE TO RELATED APPLICATIONS

This application claims priority benefit of U.S. Provisional Patent Application No. 60/836,285, filed Aug. 7, 2006, and entitled “CREATION, MANAGEMENT AND DELIVERY OF PERSONALIZED MEDIA ITEMS,” which is hereby incorporated by reference herein.

This application is related to U.S. patent application Ser. No. ______, filed concurrently herewith, and entitled “CREATION, MANAGEMENT AND DELIVERY OF MAP-BASED MEDIA ITEMS,” which is hereby incorporated by reference herein.

### BACKGROUND OF THE INVENTION

1. Field of the Invention

The present invention relates to media items and, more particularly, to creation, acquisition and playback of personalized media items.

2. Description of the Related Art

A media player stores media assets, such as audio tracks, that can be played or displayed on the media player. One example of a portable media player is the iPod® media player, which is available from Apple Computer, Inc. of Cupertino, Calif. Often, a media player acquires its media assets from a host computer that serves to enable a user to manage media assets. In managing media assets, a user can create playlists for audio tracks. These playlists can be created at the host computer. Media assets within the playlists can then be copied to the media player. As an example, the host computer can execute a media management application to acquire and manage media assets. One example of a media management application is iTunes® produced by Apple Computer, Inc.

Podcasts are typically used to share content from websites. Podcasts are associated with Really Simple Syndication (RSS) feeds which use a lightweight XML format. A podcast can be organized into episodes much like a radio or television program. An interested person can subscribe to receive podcast episodes that are subsequently published. This is achieved by the interested person using their computer to access a podcast website (i.e., subscription server) that hosts the RSS feed. The interested person can then subscribe to the RSS feed such that their computer occasionally re-visits the podcast website to check for any new podcast episodes. Typically, if a new podcast episode is available, it is downloaded to the computer. Thereafter, the interested user can play the podcast episode at their computer in the same manner as other audio files (e.g., MP3 files). A utility program can be used to download the audio files to a portable media player (e.g., MP3 player). One example of such a conventional utility program is “ipodder” which is a small program that runs on one's computer to download audio files to one's portable media player.

Conventionally, the media content within podcasts are fixed when made available to subscribers. In other words, a subscriber can choose to subscribe to a particular podcast from a plurality of established podcasts. However, a subscriber has no control over the content provided in or with podcasts. Unfortunately, however, a subscriber may desire a podcast that is somewhat different from the available podcasts. In many cases, a subscriber is not interested in the entire pre-established podcast but would prefer to modify the podcast in some manner. However, there is currently no way for a subscriber to alter the content within a podcast.

Thus, there is a need for improved techniques to enable podcast users to have greater control over the content provided in or with podcasts.

### SUMMARY OF THE INVENTION

The invention pertains to the generation, management and delivery of personalized media items for users. Users are able to influence or control content within a media item being personalized. In one embodiment, personalized media items are podcasts. Users are able to influence or control the content in or with a podcast. In other words, a podcast can be created in accordance with a user's needs or specifications so that the content within a podcast is customized or personalized for the user.

The invention can be implemented in numerous ways, including as a method, system, device, apparatus (including graphical user interface), or computer readable medium. Several embodiments of the invention are discussed below.

As a computer-implemented method for forming a podcast, the method includes at least: determining whether a custom podcast should be formed; retrieving stored podcast characteristics associated with the custom podcast to be formed; and forming the custom podcast based on the podcast characteristics.

As a computer-readable medium including at least computer program code for forming a personalized media item, one embodiment of the invention includes at least: computer program code for retrieving stored characteristics associated with the personalized media item to be formed, the stored characteristics specifying or referencing media content to be included within the personalized media item; and computer program code for forming the personalized media item based on the stored characteristics.

As a computer system, one embodiment of the invention includes at least a processor and a data storage device. The processor is configured to execute computer program code to form one or more personalized media items. The data storage device stores one or more personalized media items and the computer program code. The computer program code includes at least: computer program code for determining whether a personalized media item should be formed; computer program code for retrieving stored predetermined characteristics associated with the personalized media item to be formed; and computer program code for forming the personalized media item based on the predetermined characteristics.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a podcast media system according to one embodiment of the invention.

FIG. 2 is a block diagram of a podcast system according to one embodiment of the invention.

FIG. 3 is a diagram of a podcast creator according to one embodiment of the invention.

FIG. 4A is a flow diagram of a podcast request process according to one embodiment of the invention.

FIG. 4B is an exemplary podcast request dialog screen according to one embodiment of the invention.

FIG. 4C is an exemplary podcast request dialog screen according to another embodiment of the invention.

FIG. 5 is a flow diagram of a podcast creation process according to one embodiment of the invention.

FIG. 6 is flow diagram of a podcast delivery process according to one embodiment of the invention.

FIG. 7 is a block diagram of a representative media system according to one embodiment of the invention.

FIG. 8 is a block diagram of a media player suitable for use with the invention according to one embodiment.

### DETAILED DESCRIPTION OF THE INVENTION

The invention pertains to the generation, management and delivery of personalized media items for users. Users are able to influence or control content within a media item being personalized. In one embodiment, personalized media items are podcasts. Users are able to influence or control the content in or with a podcast. In other words, a podcast can be created in accordance with a user's needs or specifications so that the content within a podcast is customized or personalized for the user.

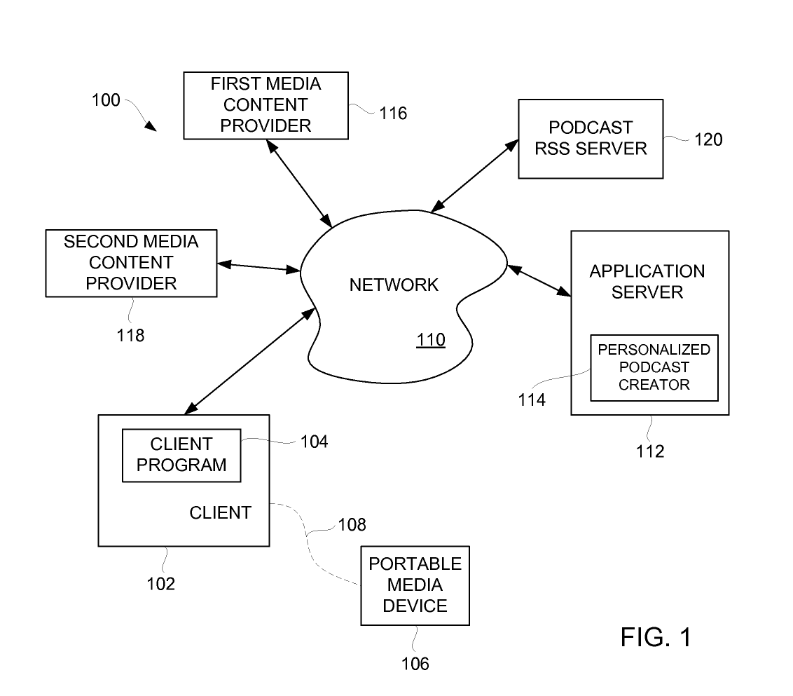

Embodiments of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a block diagram of a podcast media system 100 according to one embodiment of the invention. The podcast media system 100 supports a plurality of clients 102, though only a single client 102 is depicted in FIG. 1. The client 102 is typically a computing device, such as a personal computer. The client 102 includes a client program 104 that operates on the client 102. In one embodiment, the client program 104 can pertain to a media management application. The media management application can operate to facilitate storage, acquisition and management of media items on the client 102. One example of a media management program is iTunes® media program available from Apple Computer, Inc. which can include a Really Simple Syndication (RSS) reader. In another embodiment, the client program 104 can include a network browser and a RSS reader.

A portable media device 106 can also be connected to the client 102 over a link 108. The link 108 can be a wired link or a wireless link. The portable media device 106 is typically a hand-held or otherwise small and highly portable computing device. Examples of the portable media device 106 include a media player (e.g., music player), a PDA, a mobile telephone, etc.

The client 102 is able to couple to, and thus communicate with, a network 110, typically a data network. The network 110 is typically a global computer network, such as the World Wide Web (WWW) or the Internet. However, the network 110 can also be a wide area network or a local area network. The network 110 can include wired and/or wireless networks or sub-networks.

The podcast media system 100 also includes an application server 112 coupled to the network 110. The application server 112 is primarily responsible for production of podcast media items. In particular, the application server 112 includes a podcast creator 114. The podcast creator 114 operates to produce the podcast media items. In this regard, the podcast media items can also be referred to as podcasts as they are or can be considered to be a type of media item. A podcast is a particular type of media file, typically an audio, video or multimedia file that can include or have metadata associated therewith. The metadata can describe attributes of the podcast, such as title, description, chapter names, and images (graphics). A podcast can refer to or be associated with media content (e.g., a television show) that has episodes (e.g., periodic episodes). The episodes are the podcasts or portions thereof that can be played. More specifically, media data for the episodes can be played, thereby playing the podcasts. Additional details on the operation of the application server 112 and/or the podcast creator 114 are discussed in greater detail below.

To assist the application server 112 in making podcasts available, the podcast media system 100 can include a first media content provider server 116, a second media content provider server 118, and a podcast RSS server 120. The first media content provider server 116 makes available media content from a first media content provider. The second media content server 118 makes available media content from a second media content provider. The podcast RSS server 120 is a server that can host podcasts so that clients 102 (e.g., RSS readers therein) are able to acquire their requested podcasts.

The podcast media system 100 can produce podcasts on request by the client 102. A podcast can be automatically produced by the application server 112. Alternatively, a podcast can be requested by the client program 104 operating on the client 102. The podcast request can then be sent via the network 110 to the application server 112. Regardless, in producing a podcast, one or more indicia of the podcast to be produced are utilized. The application server 112 can request and then receive media content from the first media content provider server 116 and/or the second media content provider server 118. The podcast creator 114 within the application server 112 can then operate to create the podcast being requested using at least the one or more media items received from the first media content provider 116, the second media content provider 118, or some other source for media content. Thereafter, the podcast can be stored on the podcast RSS server 120. While stored at the podcast RSS server 120, the podcast is able to be accessed and acquired by the client 102 via the network 110. The client program 104 can then interact with the podcast RSS server 120 to retrieve any available podcasts. Typically, the client program 104 periodically interacts with the podcast RSS server 120 to retrieve any available podcasts. In this regard, the application server 112 can also notify the client 102 that a podcast is now available from the podcast RSS server 120.

Furthermore, once the client program 104 includes the requested podcast, the client program 104 can transfer or copy the podcast to the portable media device 106. In any event, once the requested podcast is resident at the client 102 or the portable media device 106, the podcast is able to be played on such devices. Due to their support of media playback, the client 102 and the portable media device 106 can also be referred to as media playback devices. When being played, the podcast presents media to the user of the device. As noted above, the media can include media items of interest to the user. For example, the media items can be news pieces, sports highlights, local/national weather information, financial news, etc. It is useful to play such podcasts on the portable media device 106 because it can be easily carried or transferred by the user.

In other embodiments, one or more of the first media content provider 116, the second media content provider 118 or the podcast RSS server 120 of the podcast media system 100 can be incorporated into a common server. The application server 112 can also be the common server.

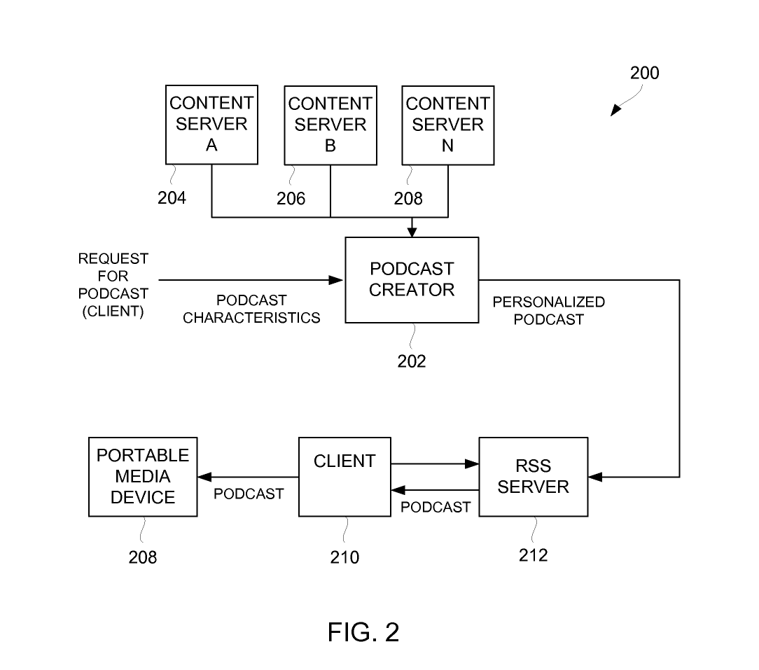

FIG. 2 is a block diagram of a podcast system 200 according to one embodiment of the invention. The podcast system 200 provides a representative data flow view for creation and delivery of a personalized podcast. The podcast system 200 can, for example, be provided by the podcast media system 100 illustrated in FIG. 1.

The podcast system 200 initially receives a request for a personalized podcast. The request for the podcast would typically come from a requester. In one embodiment, the request for a podcast would include at least criterion (podcast criterion) that specify or reference characteristics of the personalized podcast to be created. In one embodiment, the criterion includes information to identify one or more categories (content categories). The criterion can also include information on at least time periods and/or at least one type of media item. The criterion can also specify how frequently the requester desires to have such podcasts created. The requester can pertain to the client (e.g., client 102), a client program (e.g., client program 104) or a user of the client or client program.

The podcast criterion is provided to a podcast creator 202. The podcast creator 202 would receive the podcast criterion. The podcast creator 202 would then process the podcast criterion to determine the media data to be acquired for the podcast. Here, the podcast creator 202 could interact with one or more media content servers. The media content servers, for example, can include content server A 204, content server B 206, . . . , content server N 208. The podcast creator 202 can retrieve media content from any one or more of the content servers 204, 206 and 208 when creating the personalized podcast. In one embodiment, the podcast to be created is personalized in view of the particular request for a podcast. The resulting podcast can then be provided to a subscription server 210 (e.g., RSS server) where it is made available for download to a client 212. Typically, to download the podcast, the client 212 would request the podcast from the RSS server 210 and then receive the podcast at the client 212. The client 212 can also thereafter download the podcast to a portable media device 214. Once the podcast is stored on the client 212 or the portable media device 214, the podcast can be played to, in effect, present the personalized media of the podcast to the user of the client 210 or the portable media device 214.

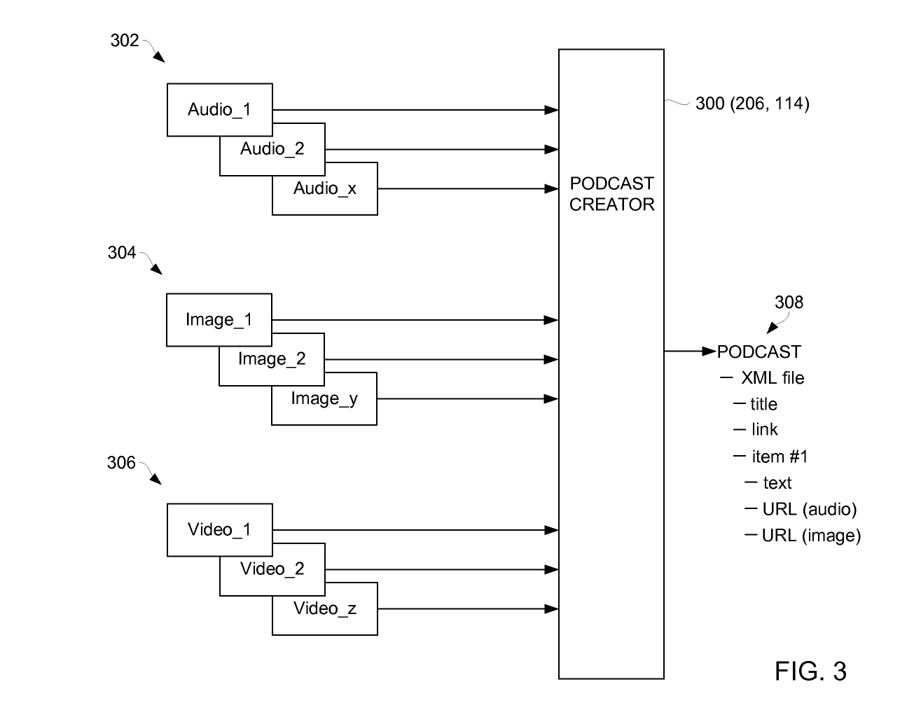

FIG. 3 is a diagram of a podcast creator 300 according to one embodiment of the invention. The podcast creator 300 is, for example, suitable for use as one embodiment of the podcast creator 202 illustrated in FIG. 2 or the podcast creator 114 illustrated in FIG. 1. As illustrated in FIG. 3, first, second, third, . . . , xth audio segments 302 are utilized; first, second, third, . . . yth image segments 304 are utilized; and first, second, third, . . . zth video segments 306 are utilized.

As depicted in FIG. 3, the podcast creator 300 operates on the audio 302, images 304 and videos 306 when creating a podcast having a plurality of items. These items can correspond to different episodes. In one embodiment, the different items correspond to different segments. Each of the items can be designed to present one or more of text, audio, image or video. Each item can also include a link (e.g., Universal Resource Locator (URL)) to additional information, such as the corresponding audio, image or video segment.

The podcast 308 is typically a mark-up language file, such as an extensible Markup Language (XML) file. The organization of the mark-up language file can vary with implementation. In one implementation, the XML file includes at least a title for the podcast and a link specifying where the RSS feed resides. The link specifies the network location of the RSS feed for the podcast (e.g., location on the podcast RSS server 124, 212).

The podcast creator 300 is able to create a podcast. In one embodiment, a podcast creator can create a podcast from one or more audio, text and possibly image inputs. Various programs are known that assist users in creating podcasts. For example, GarageBand® available from Apple Computer, Inc. can be used to create podcasts. More recently, podcasts have been able to include video.

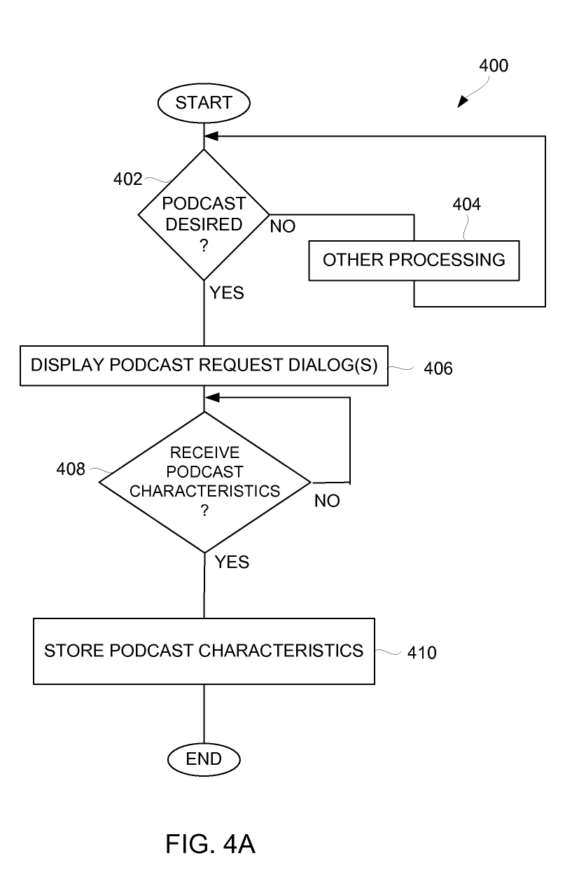

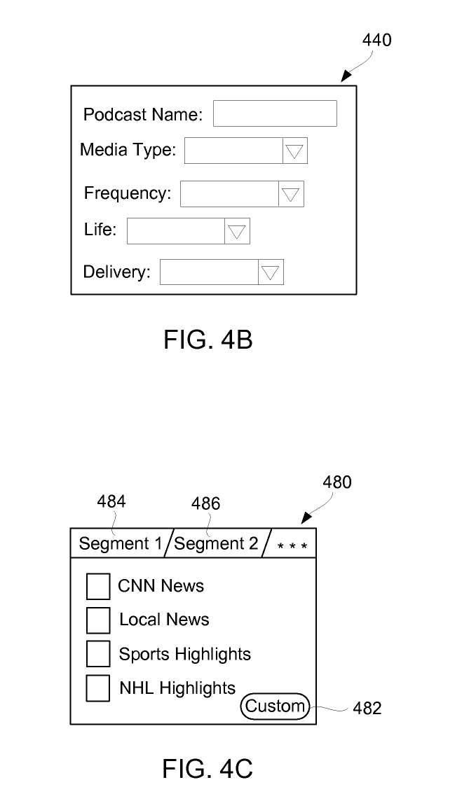

FIG. 4A is a flow diagram of a podcast request process 400 according to one embodiment of the invention. The podcast request process 400 is, for example, performed by the client program 104 operating on the client 102 illustrated in FIG. 1.

The podcast request process 400 begins with a decision 402. The decision 402 determines whether a personalized podcast is desired. A user of the client 102 can signal their desire to acquire a particular podcast, such as by interaction with a user interface of the client 102. The particular podcast is a personalized podcast for use by the user. When the decision 402 determines that a podcast is not desired, then other processing 404 can be performed. However, when the decision 402 determines that a podcast is desired, at least one podcast request dialog is displayed 406. Here, the client 102 typically includes a display and the client program 104 operates to cause a podcast request dialog to be displayed 406. In one embodiment, the podcast request dialog enables the user to specify characteristics of a podcast desired by the user. In one embodiment, a decision 408 can determine whether podcast characteristics have been received. When the decision 408 determines that the podcast characteristics have not yet been received, the podcast request process 400 can await receipt of such podcast characteristics. On the other hand, when the decision 408 determines that the podcast characteristics have been received, then the podcast characteristics are saved 410. In one embodiment, the podcast characteristics are saved on the client (e.g., saved locally), such as the client 102. In another embodiment, the podcast characteristics are saved remotely, such as on a server (e.g., application server 112). In still another embodiment, the podcast characteristics are saved on the client and the server. After the podcast characteristics have been saved 410, the podcast request process 400 can end.

A graphical user interface can assist a user in designating characteristics of podcasts to be created for and delivered to the user.

FIG. 4B is an exemplary podcast request dialog screen 440 according to one embodiment of the invention. The dialog screen 440 assists a user in requesting a custom podcast. In this example, the dialog screen 440 enables a user to enter a podcast name, frequency, life (or duration), and delivery. The podcast name provides a name for the podcast (“mypodcast”). The frequency can indicate how frequently the user desires that the podcast be formed (e.g., daily, weekly). The life can indicate how long such custom podcasts are to be provided (e.g., one month, one year, always).

FIG. 4C is an exemplary podcast request dialog screen 480 according to another embodiment of the invention. The dialog screen 480 assists a user in requesting content to be included in a custom podcast. In one embodiment, the dialog screen 480 includes predetermined categories from which a user can select different categories, groups and/or types of content (e.g., media content) for a custom podcast. The predetermined categories can, for example, pertain to news (local or national), weather (local or national), sports highlights, comedy, political, financial, etc. For example, the predetermined categories shown in FIG. 4C are CNN News, Local News, Sports Highlights, and NHL Highlights. The dialog screen 480 can be organized into different segments. As shown in FIG. 4C, the dialog screen 480 includes a first segment (Segment 1) tab 484 and a second segment (Segment 2) tab 486. The segments can correspond to segments/chapters/sections within the custom podcast. Hence, by selection of the different segment tabs 484 and 486, the user can specify a different predetermined category for each of the different segments of the custom podcast to be generated.

Besides the predetermined categories shown in FIG. 4C, the dialog screen 480 includes a custom button 482. Upon selection of the custom button 482, a user can be assisted with another dialog screen to create a category of content, namely, media content, that is to be included within the custom podcast. For example, in the case of sports, the user may desire to create a category that is specific to their interests. For example, the user may request to receive sports highlights from the weekend during the NFL season regarding specific teams or teams in the Eastern division. As another example, the user may desire to receive statistics regarding games played during the past week in the NFL.

Still further, the dialog screens 440 and 480 can further provide a description of the predetermined categories or permit access to a description of such predetermined categories. A custom podcast can pertain to a single category or can contain a plurality of different categories. A user can even control or influence the length of the content provided for a custom podcast or an individual category or topic within a podcast.

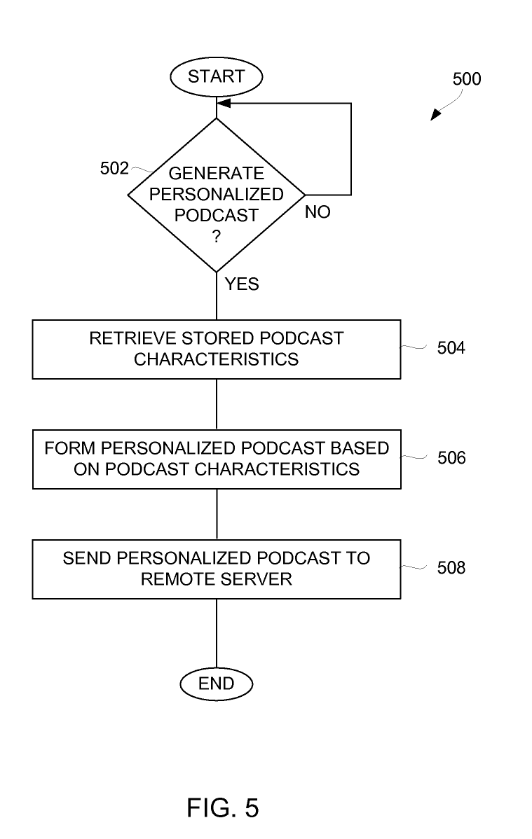

FIG. 5 is a flow diagram of a podcast creation process 500 according to one embodiment of the invention. The podcast formation process 500 is, for example, performed by a computing device, such as a server. More particularly, the podcast formation process 500 can be performed by the podcast creator 114 of the application server 112 illustrated in FIG. 1 or the podcast creator 202 illustrated in FIG. 2.

The podcast creation process 500 begins with a decision 502. The decision 502 determines whether a personalized podcast is to be generated. When the decision 502 determines that a personalized podcast is not be generated, then the podcast creation process 500 waits until a personalized podcast is to be generated. In other words, the podcast creation process 500 is effectively invoked when a personalized podcast is to be created.

In any case, when the decision 502 determines that a personalized podcast is to be generated, stored podcast characteristics are retrieved 504. The stored podcast characteristics can, for example, correspond to part of the podcast characteristics that were stored at block 410 of the podcast request process 400. Next, a personalized podcast is formed 506 based on the podcast characteristics. The personalized podcast is then sent 508 to a remote server. As an example, the remote server can pertain to the podcast RSS server 120 illustrated in FIG. 1. Following the sending 508 of the personalized podcast to the remote server, the podcast creation process 500 can end.

The podcast creation process 500 is typically performed in an automated manner by the server. In this embodiment, the podcast creation process 500 determines when a podcast is to be created. However, a user could contribute to determining when a personalized podcast is to be generated. For example, a user could influence when a personalized podcast is generated by having set one or more preferences or other settings that are examined or utilized by a server when evaluating the decision 502. In another embodiment, a user or client could initiate generation of a personalized podcast.

Further, a personalized podcast could contain other content. For example, advertisements can be presented on the media playback device, such advertisements can be provided between requested content segments and can include one or more of text, audio or video. Also, a media playback device might be able to concurrently output the requested personalized podcast content as well as other content (music, ads, etc.) during certain segments.

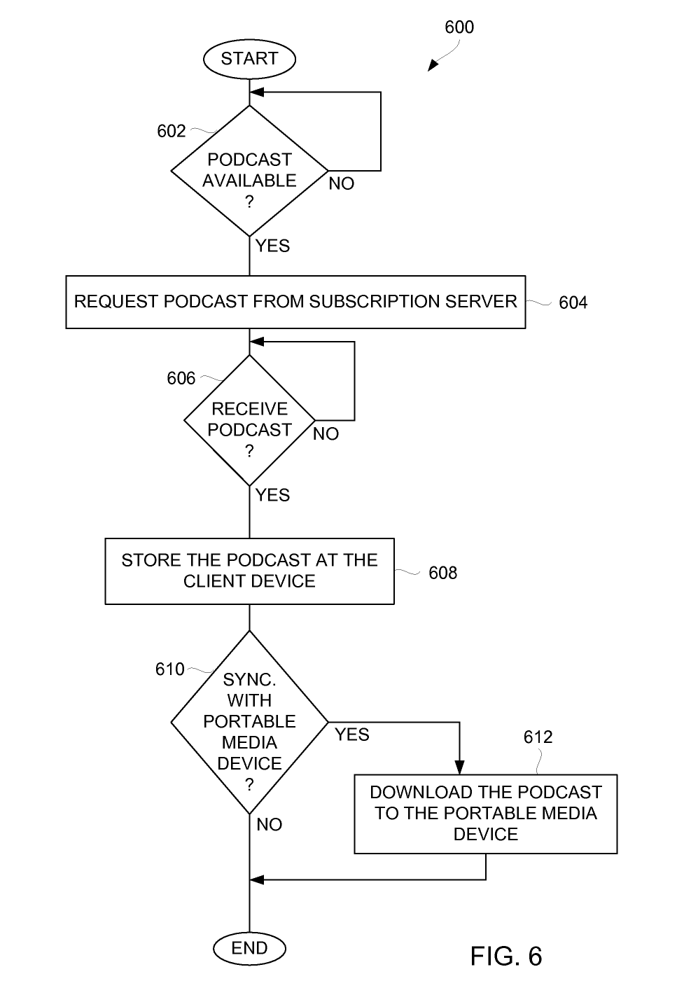

FIG. 6 is flow diagram of a podcast delivery process 600 according to one embodiment of the invention. The podcast delivery process 600 is, for example, performed by a client program operating on a client. The client, for example, can be the client 102 illustrated in FIG. 1 or the client 210 illustrated in FIG. 2.

The podcast delivery process 600 begins with a decision 602. The decision 602 determines whether a podcast is available. The decision 602 can be performed by a periodic polling of an appropriate subscription server or can be performed in response to being notified that a podcast is newly available or updated at the appropriate subscription server. For example, the podcast formation process 500 can notify the client that the podcast is available. In any case, when the decision 602 determines that a podcast is not available, the podcast delivery process 600 awaits the availability of a podcast. On the other hand, when the decision 602 determines that a podcast is available, the podcast delivery process 600 continues. In other words, the podcast delivery process 600 can be deemed to be invoked when a podcast becomes available.

Once a podcast is determined to be available, the podcast is requested 604 from the subscription server. A decision 606 then determines whether the podcast has been received. When the decision 606 determines that the podcast has not been received, then the podcast delivery process 600 awaits the receipt of the podcast. Once the podcast has been received, the podcast can be stored 608 at the client device (e.g., client 102 or 210).

Next, a decision 610 can determine whether synchronization with a portable media device is to be performed. Synchronization can be performed automatically by the client device or can be performed on-demand from a user of the client device. In any case, when the decision 610 determines that synchronization with the portable media device is to be performed, the podcast is downloaded 612 to the portable media device. In order to download the podcast to the portable media device, the portable media device must be able to communicate with the client device. For example, the portable media device can be connected to the client device by way of (i) direct coupling, (ii) a cable, or (iii) wireless link. Once on the portable media player, the user of the portable media player can start its playback. Once played, the personalized media item provides audio and/or graphical outputs for the user. In one embodiment, the audio and/or graphical outputs are media segments (e.g., media items) that are associated with podcast characteristics previously specified by the user. Following the block 612, as well as following the decision 610 when synchronization is not to be performed, the podcast delivery process 600 ends.

Note that a podcast can be considered a podcast or one or more episodes of a podcast. Hence, a reference as used herein to a podcast may refer to a podcast as a whole or one or more episodes of a podcast.

In the various processes discussed above with reference to FIGS. 3, 4A, 5 and 6, decision blocks are represented. Although the processes are indicated as waiting for the condition of the decisions to be satisfied, in the event that the decisions are not satisfied in a timely fashion, the corresponding processes could time-out. Alternatively, the corresponding processes can be implemented by separate processes (or threads) that can be utilized to await the decisions to be satisfied.

For additional organization and management of podcasts, the podcasts can be stored at the subscription server in accordance with registered user accounts or a group of user accounts. For example, a user account/group account can be accessed if the requester can provide the appropriate user name and password. Additionally, created podcasts when stored to the subscription server can be stored so that they are associated with a particular user account/group account. As an example, a user may have a “my podcast” labeled podcast group stored at the subscription server which can be downloaded as appropriate to the client device associated with the user. In one embodiment, any subsequent podcasts for that user would be stored to the “my podcast” labeled podcast group as additional episodes.

In addition, for management of podcasts, a client device or a portable media device can also be configured so that the podcasts are automatically maintained or discarded based on any of a number of different criteria. For example, the number of podcasts (or episodes thereof) being maintained could be limited and the oldest stored podcast can be deleted when more than the predetermined number of podcasts (or episodes thereof) is being stored. As another example, the deletion of podcasts (or episodes thereof) can be based on usage so that those podcasts (or episodes thereof) that have not been used for an extended period of time can be automatically deleted. As still another example, the deletion of podcasts (or episodes thereof) can be based on usage so that those podcasts (or episodes thereof) that have been significantly played can be automatically deleted, or those podcasts (or episodes thereof) that are now out of date or no longer timely can be automatically deleted. Still further, a user can set preferences (including deletion policies) to control how the podcasts are maintained by the client device or the portable media device.

Although the discussion above focuses on creation, management and delivery of personalized media, such as a podcasts, the invention extends beyond creation, management and delivery of personalized podcasts. Indeed, the invention is applicable to any type of media content that can be organized and assembled into an electronic file and be provided to a client device.

The clients and the portable media devices and their operations discussed above can be used within a media system that supports purchase, management and usage of media assets.

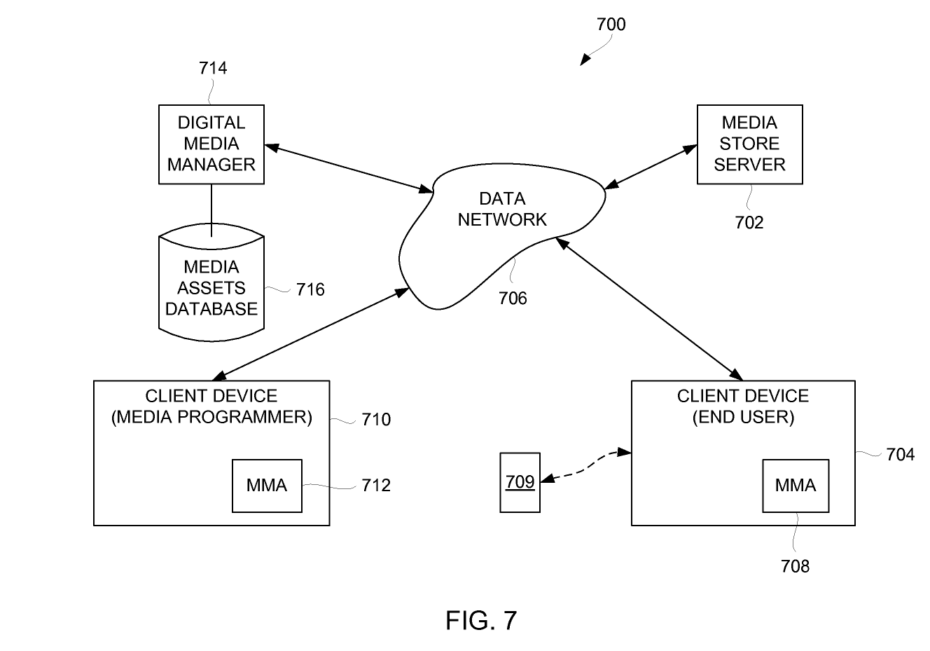

FIG. 7 is a block diagram of a representative media system 700 according to one embodiment of the invention. The media system 700 can be used in conjunction with the podcast media system 100 illustrated in FIG. 1.

The media system 700 includes a media store server 702 that hosts an on-line media store. The media store server 702 can off-load commerce transactions and/or delivery of purchased digital media assets to other servers, if desired. As shown in FIG. 7, the media system 700 includes one or more client devices 704 for use by end users. The client devices 704 couple to a data network 706. Additionally, the media store server 702 also couples to the data network 706. In one implementation, the data network 706 can refer to one or more data networks, typically high data-bandwidth networks; namely, wired networks, such as the Internet, Ethernet, gigabit Ethernet, and fiber optic, as well as wireless networks such as IEEE 702.11(a),(b) or (g) (WiFi), IEEE 702.16 (WiMax), and Ultra-Wide Band (UWB).

A computer program 708, typically a media management application (MMA) or other media player application, runs on the client device 704. One example of a media management application is the iTunes® application, produced by Apple Computer, Inc. of Cupertino, Calif. The client devices 704 are, in general, computing devices. As an example, the client devices 704 can be specific or general-purpose personal computers or portable media players. The client device can couple to a portable media device 709 (portable media player). One example of a portable media player suitable for use with the invention is the iPod®, also produced by Apple Computer, Inc. The computer program 708 can be used by a consumer for a variety of purposes, including, but not limited to, browsing, searching, acquiring and/or purchasing media assets (including podcasts) from the on-line media store provided by the media store server 702, creating and sharing media asset groups (e.g., playlists), organizing media assets, presenting/playing media assets, transferring media assets between client devices 704, and synchronizing with portable media devices. In relation to the podcast media system 100, the client device 704 corresponds to the client 102, the computer program 708 corresponds to the client program 104, the data network 706 corresponds to the network 110, and the portable media player 709 corresponds to the portable media device 106.

The media system 700 can also include one or more client devices 710 for use by media programmers. The client devices 710 also run a computer program 712, typically a media management application (MMA) or other media player application. The computer program 712 can enable a media programmer to create and publish podcasts.

The media system 700 also includes a digital asset manager 714. The digital asset manager 714 is coupled to a media assets database 716. The media assets database 716 stores media asset information including metadata relating to digital media assets available for purchase at the on-line media store. The metadata can pertain to individual media assets (digital media assets) or media asset groups (digital media asset groups). Media assets can include, but are not limited to, music, video, text, and/or graphics files. One particular type of media asset is a podcast, which often includes audio, graphics and text (but could also include video). In the case of music, a media asset group can be a playlist for the music.

The media store server 702 enables the user of a particular client device 704 to acquire media assets (e.g., podcasts). Subsequently, the client device 704 can download the media assets from the media store server 702 or some other server via the data network 706. As will be understood by those familiar with data networks, other network configurations are possible. Furthermore, while the media store server 702 and the digital asset manager 714 are shown as individual and separate devices, it will be understood by those familiar with the art that other configurations are possible. As one example, each device can be implemented such that it is distributed over multiple server computers. As another example, these various servers and/or managers can be implemented by a single physical server computer.

The portable media device as described herein can be a media player capable of playing (including displaying) media items. The media items can pertain to audio items (e.g., audio files or songs), videos (e.g., movies) and/or images (e.g., photos). Examples of particular types of media items include podcasts.

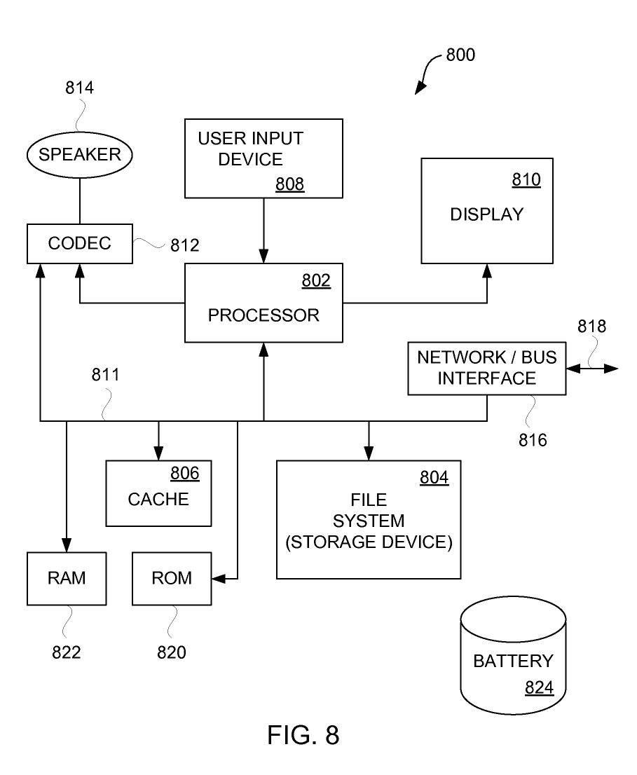

FIG. 8 is a block diagram of a representative media player 800 suitable for use with the invention according to one embodiment. The media player 800 illustrates circuitry of a representative portable media device (e.g., portable media device 106, 706).

The media player 800 includes a processor 802 that pertains to a microprocessor or controller for controlling the overall operation of the media player 800. The media player 800 stores media data pertaining to media items in a file system 804 and a cache 806. The file system 804 is, typically, a storage device, such as a FLASH memory or one or more storage disks. The file system 804 typically provides high capacity storage capability for the media player 800. However, since the access time to the file system 804 is relatively slow, the media player 800 can also include a cache 806. The cache 806 is, for example, Random-Access Memory (RAM) provided by semiconductor memory. The relative access time to the cache 806 is substantially shorter than for the file system 804. However, the cache 806 does not have the large storage capacity of the file system 804. Further, the file system 804, when active, consumes more power than does the cache 806. The power consumption is often a concern when the media player 800 is a portable media player that is powered by a battery (not shown). The media player 800 also includes a RAM 820 and a Read-Only Memory (ROM) 822. The ROM 822 can store programs, utilities or processes to be executed in a non-volatile manner. The RAM 820 provides volatile data storage, such as for the cache 806.

The media player 800 also includes a user input device 808 that allows a user of the media player 800 to interact with the media player 800. For example, the user input device 808 can take a variety of forms, such as a button, keypad, dial, touch surface, etc. Still further, the media player 800 includes a display 810 (screen display) that can be controlled by the processor 802 to display information to the user. A data bus 811 can facilitate data transfer between at least the file system 804, the cache 806, the processor 802, and the CODEC 812.

In one embodiment, the media player 800 serves to store a plurality of media items (e.g., songs, podcasts, etc.) in the file system 804. When a user desires to have the media player play a particular media item, a list of available media items is displayed on the display 810. Then, using the user input device 808, a user can select one of the available media items. The processor 802, upon receiving a selection of a particular media item, supplies the media data (e.g., audio file) for the particular media item to a coder/decoder (CODEC) 812. The CODEC 812 then produces analog output signals for a speaker 814. The speaker 814 can be a speaker internal to the media player 800 or external to the media player 800. For example, headphones or earphones that connect to the media player 800 would be considered an external speaker.

The data link 818 allows the media player 800 to couple to a host computer, power source or accessory device. Depending on application, the data link 818 can be provided over a wired connection or a wireless connection. In the case of a wireless connection, the network/bus interface 816 can include a wireless transceiver.

The media items (media assets) can pertain to one or more different types of media content. In one embodiment, the media items are audio tracks (e.g., songs, audiobooks, podcasts). In another embodiment, the media items are images (e.g., photos). However, in other embodiments, the media items can be any combination of audio, graphical or video content.

Additionally, the following applications are hereby incorporated herein by reference: (i) U.S. patent application Ser. No. 11/166,333, filed Jun. 25, 2005, and entitled “TECHNIQUES AND SYSTEMS FOR SUPPORTING PODCASTING;” (ii) U.S. patent application Ser. No. 11/166,331, filed Jun. 25, 2005, and entitled “TECHNIQUES AND SYSTEMS FOR SUPPORTING PODCASTING;” (iii) U.S. patent application Ser. No. 11/166,332, filed Jun. 25, 2005, and entitled “ACQUISITION, MANAGEMENT AND SYNCHRONIZATION OF PODCASTS;” (iv) U.S. patent application Ser. No. 11/369,480, filed Mar. 6, 2006, and entitled “MEDIA PRESENTATION WITH SUPPLEMENTARY MEDIA;” and (v) U.S. patent application Ser. No. 10/277,418, filed Oct. 21, 2002, and entitled “INTELLIGENT INTERACTION BETWEEN MEDIA PLAYER AND HOST COMPUTER.”

The various aspects, embodiments, implementations or features of the invention can be used separately or in any combination.

The invention is preferably implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that personalized podcasts can be created and delivered to particular requesters. Another advantage of the invention is that podcasts can be personalized by user-provided criteria. Another advantage of the invention is that podcasts can be automatically produced and delivered to media playback devices. Another advantage of the invention is that personalized podcasts can be managed and maintained on media playback devices.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for forming a podcast, said method comprising:
(a) determining whether a custom podcast should be formed;
(b) retrieving stored podcast characteristics associated with the custom podcast to be formed; and
(c) forming the custom podcast based on the podcast characteristics.

2. A computer-implemented method as recited in claim 1, wherein said determining (a) is based on at least one criteria provided by a requester.

3. A computer-implemented method as recited in claim 1, wherein the podcast characteristics specify media content to be included within the custom podcast.

4. A computer-implemented method as recited in claim 1, wherein the podcast characteristics specify or reference characteristics of the custom podcast to be formed.

5. A computer-implemented method as recited in claim 1, wherein the podcast characteristics include one or more content categories to be included in the custom podcast.

6. A computer-implemented method as recited in claim 5, wherein the podcast characteristics further include a time period or a type of media item.

7. A computer-implemented method as recited in claim 1, wherein the podcast characteristics specify how frequently the requester desires to have such custom podcasts formed.

8. A computer-implemented method as recited in claim 1,
wherein the custom podcast is requested by a requester, and
wherein the stored podcast characteristics were previously provided by the requester.

9. A computer-implemented method as recited in claim 1, wherein said method further comprises:
(d) providing the custom podcast to a media playback device.

10. A method as recited in claim 1, wherein said method further comprises:
(d) providing the custom podcast to a remote server.

11. A computer-implemented method as recited in claim 10,
wherein said method further comprises: (e) receiving a download request for the custom podcast, and
wherein the request for the custom podcast is from a client program operating on a client device.

12. A computer-implemented method as recited in claim 11, wherein said method further comprises:
(f) sending the custom podcast from the remote server to the client device.

13. A computer-implemented method as recited in claim 12, wherein the client device is a media playback device.

14. A computer-implemented method as recited in claim 12, wherein said method further comprises:
(f) transferring the custom podcast from the client device to a portable media playback device.

15. A computer-implemented method as recited in claim 14, wherein the portable media playback device is a handheld device.

16. A computer-implemented method as recited in claim 1, wherein said forming (c) of the custom podcast utilizes media content.

17. A computer-implemented method as recited in claim 16, wherein the media content for the custom podcast is obtained from one or more content servers.

18. A computer-implemented method as recited in claim 1, wherein said method further comprises:
(d) rendering the map-based media item available to be provided to the portable media playback device.

19. A computer-implemented method as recited in claim 18, wherein the request for the custom podcast is from a client, and
wherein said rendering (d) includes at least:
(d1) causing the custom podcast to be stored to a RSS server; and
(d2) providing, to the client, a network address pertaining to the custom podcast at the RSS server.

20. A computer-implemented method as recited in claim 19, wherein said method further comprises:
(e) retrieving the custom podcast from the RSS server using the network address.

21. A computer-implemented method as recited in claim 20, wherein said retrieving (e) comprises:
(e1) providing the network address to a RSS reader associated with the client;
(e2) subsequently causing the RSS reader to request some or all of the data at the RSS server for the custom podcast;
(e3) receiving the requested data for the custom podcast from the RSS server;
(e4) storing the requested data at the client; and
(e5) copying the requested data from the client to the portable media playback device.

22. A computer-readable medium including at least computer program code for forming a personalized media item, said computer-readable medium comprising:
computer program code for retrieving stored characteristics associated with the personalized media item to be formed, the stored characteristics specifying or referencing media content to be included within the personalized media item; and
computer program code for forming the personalized media item based on the stored characteristics.

23. A computer-readable medium as recited in claim 22, wherein the stored characteristics were previously provided by a requester.

24. A computer-readable medium as recited in claim 22, wherein said computer-readable medium further comprises:
computer program code for determining whether a personalized media item should be formed.

25. A computer-readable medium as recited in claim 22, wherein the stored characteristics specify or reference characteristics of the custom podcast to be formed.

26. A computer-readable medium as recited in claim 22, wherein the stored characteristics include one or more categories.

27. A computer-readable medium as recited in claim 22, wherein said computer-readable medium further comprises:
computer program code for providing the personalized media item to a media playback device.

28. A computer-readable medium as recited in claim 22, wherein said computer-readable medium further comprises:
computer program code for providing the personalized media item to a remote server.

29. A computer-readable medium as recited in claim 22, wherein said computer program code for forming the personalized media item utilizes media content.

30. A computer-readable medium as recited in claim 29, wherein the media content for the personalized media item is obtained from one or more content servers.

31. A computer-readable medium as recited in claim 22, wherein said computer readable medium further comprises:
computer program code for rendering the personalized media item available at a client to be provided to a portable media playback device.

32. A computer-readable medium as recited in claim 31, wherein said computer program code for rendering includes at least:
computer program code for causing the personalized media item to be stored to a RSS server; and
computer program code for providing, to the client, a network address pertaining to the personalized media item at the RSS server.

33. A computer-readable medium as recited in claim 32, wherein said computer program code further comprises:
computer program code for retrieving the personalized media item from the RSS server using the network address.

34. A computer-readable medium as recited in claim 33, wherein said computer program code for retrieving comprises:
computer program code for providing the network address to a RSS reader associated with the client;
computer program code for subsequently causing the RSS reader to request some or all of the data at the RSS server for the personalized media item;
computer program code for receiving the requested data for the personalized media item from the RSS server;
computer program code for storing the requested data at the client; and
computer program code for copying the requested data from the client to the portable media playback device.

35. A computer readable medium as recited in claim 22, wherein the personalized media item is an episode of a podcast.

36. A computer system, comprising:
a processor for executing computer program code to form one or more personalized media items; and
a data storage device that stores one or more personalized media items and computer program code,
wherein the computer program code includes at least:
computer program code for determining whether a personalized media item should be formed;
computer program code for retrieving stored predetermined characteristics associated with the personalized media item to be formed; and
computer program code for forming the personalized media item based on the predetermined characteristics.

37. A computer system as recited in claim 36, wherein the personalized media item is a podcast or an episode of the podcast.
